(19) United States
(12) Patent Application Publication
(10) Pub. No.: US 2009/0064877 A1
(43) Pub. Date: Mar. 12, 2009

(54) Apparatus for perforating and deforming containers

(76) Inventor: Jan Benjamins, Elim (NL)

Correspondence Address: PEARNE & GORDON LLP, 1801 EAST 9TH STREET, SUITE 1200, CLEVELAND, OH, 44114-3108, US

(21) Appl. No.: 12/220,246

(22) Filed: Jul. 23, 2008

(30) Foreign Application Priority Data
Jul. 23, 2007 (EP) 07112961.3

(51) Int. Cl. B30B 9/30; B02C 18/00

(52) U.S. Cl. 100/98 R; 100/176; 241/280

(57) ABSTRACT

An apparatus for perforating and deforming containers is equipped with a perforating rotor (6) including sharp perforating elements on an outer circumference for perforating containers in a transport path. The perforating rotor (6) is rotatable about an axis of rotation on a first side of the transport path (4) and oriented transverse to the transport direction (5). A pressing rotor (7) for pressing the containers against the perforating rotor (6) is rotatable about an axis of rotation on a second side of the transport path (4), opposite the perforating rotor (6) and oriented transverse to the transport direction (5) and comprises circumferentially distributed fingers (8) each projecting in a direction radial and circumferential to the axis of rotation of the pressing rotor (7). A drive is provided for driving rotation of the perforating rotor (6) and the pressing rotor (7) in a sense of rotation such that sections of the rotors (6, 7) facing the transport path (4) move in directions having a component in the transport direction (5).

### TECHNICAL FIELD AND BACKGROUND ART

The invention relates to an apparatus for perforating and deforming containers. In the waste recycling industry, large quantities of containers, such as plastic bottles, are recollected for re-use of the material of which the containers are made. To store and transport these containers economically the containers are compressed, generally into bales. Containers are also deformed to prevent the containers from rolling when passed by sorting equipment, for instance equipment in which bottles are sorted after having been identified using optical recognition sensors.

Since many of the collected containers have been disposed of with the cap on, and are therefore in a hermetically sealed condition, effective compression of the containers requires that the containers are first punctured so that air or other fluids inside the container can escape as the container is compacted, and explosion of containers is prevented.

In U.S. Pat. No. 6,131,509 an apparatus for compressing plastic containers is described, in which a transport path for transporting containers is formed by a first screen of rotatable shafts carrying perforating elements. A second screen of rotatable shafts also carrying perforating elements is suspended above, and at an angle to the first screen. The second screen is positioned such that the distance between the two screens becomes progressively smaller in the transport direction and closes in on the containers, deforming them between shafts of the first and second pluralities of shafts. At the same time, the perforating elements pierce the containers, permitting any contents to flow out. Thus, the containers are gradually compressed as they are pierced and travel between the first and second screens. The containers continue to travel between the first and second shafts eventually emerging through the discharge opening.

The upper screen is hingeably supported for moving away from the transport path when non or less compressible objects are transported between the two screens, but requires a relatively evenly distributed deformability of the container material flow.

### SUMMARY OF THE INVENTION

It is an object of the invention to provide a system that reliably perforates and deform containers and exhibits little sensitivity to fluctuations in deformability of the container material supply, both in transport direction and across the width of the transport path. According to the present invention, this object is achieved by providing an apparatus according to claim 1.

Furthermore, between surfaces on leading sides of the fingers and the perforating rotor, intermittently, each time a finger approaches the perforating rotor, a gap occurs of which the width decreases as the rotors continue to rotate. In the gap, containers are reliably caught and held in spite of the absence of perforating elements on the side of the pressing rotor. Moreover, the intermittently occurring gaps also function to some extent to regulate the amount of containers accepted between the pressing rotor and the perforating rotor since only a limited amount of containers is accepted in the gap and containers that do not fit in will be caught in the next gap between the next finger and the perforating rotor.

Particular embodiments of the invention are set forth in the dependent claims. Further aspects, effects and details of the invention are described with reference to an example of an apparatus according to the invention, shown in the drawings.

### BRIEF DESCRIPTION OF THE DRAWINGS

FIG. 1 is a perspective view of an example of an apparatus according to the invention;

FIG. 2 is a partly cut-away side view of the apparatus shown in FIG. 1; and

FIG. 3 is another perspective view of the apparatus shown in FIGS. 1 and 2.

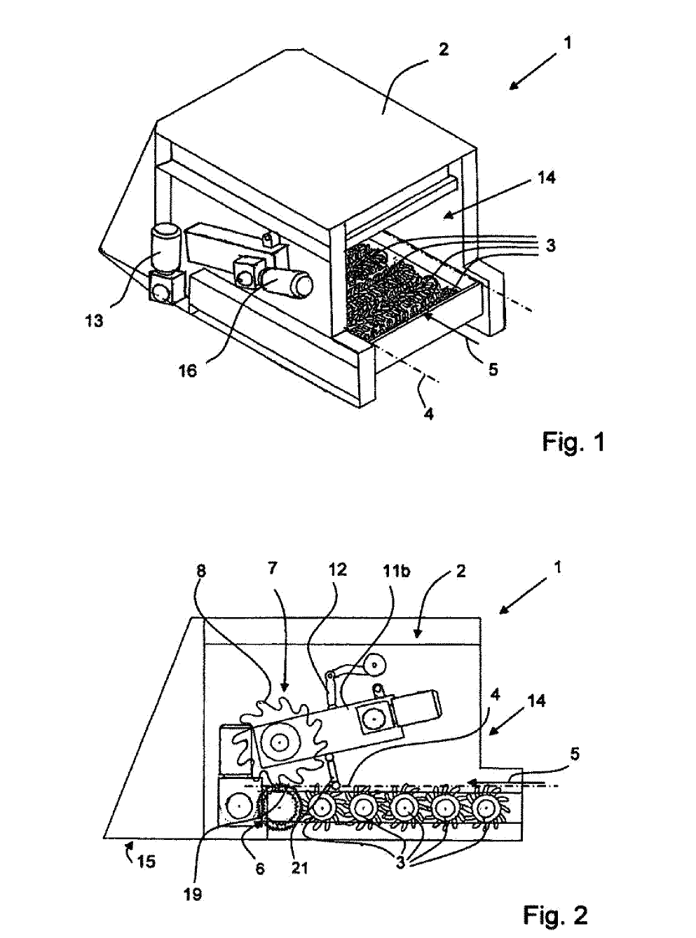

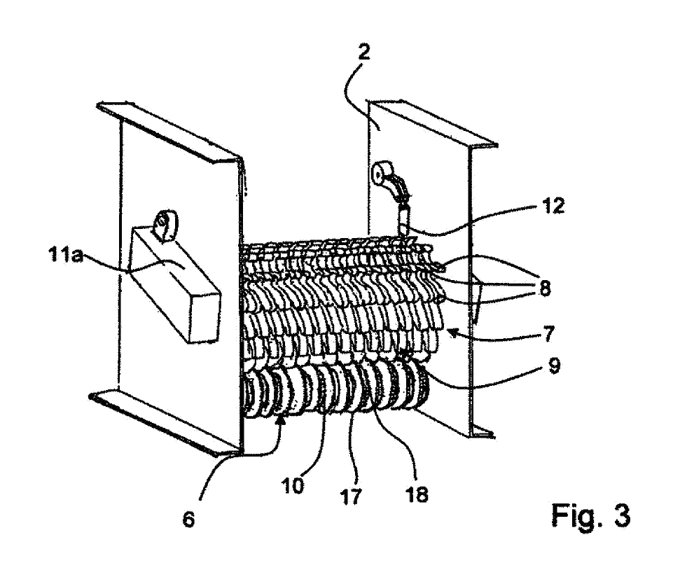

### MODES FOR CARRYING OUT THE INVENTION

The apparatus 1 according to the example shown in the drawings has a frame 2, having an entry opening 14 for feeding containers to be deformed, and a discharge opening 15 for discharging deformed containers from the apparatus.

A plurality of transport screen rotors 3 form a transport screen defining a transport path 4 for transporting containers in a transport direction, indicated by an arrow 5. According to the present example, the rotors are each composed of a shaft rotatably suspended by the frame 2 and star bodies rotationally fixed to the shaft. Preferably, the containers are transported as a stream without overlapping each other.

A downstream end of the screen is formed by a perforating rotor 6. Opposite the perforating rotor 6, a pressing rotor 7 is arranged for pressing containers against the perforating rotor 6 for causing the containers to be perforated and deformed. The perforating rotor 6 and the pressing rotor are both suspended to the frame for rotation about respective axes of rotation that coincide with centre lines of the respective rotors 6, 7. Motors 13, 16 are provided as drives for driving rotation of the pressing rotor 7 and the perforating rotor 6 as well as rotation of the transport screen rotors 3. When in operation, the perforating rotor 6 and the pressing rotor 7 are driven in senses of rotation such that sections of the rotors 6, 7 facing the transport path 4 move with a directional component in the transport direction 5.

The pressing rotor 7 has elongated, resilient fingers 8 projecting radially and circumferentially relative to the axis of rotation of the pressing rotor 7.

In operation, containers to be deformed are fed to the apparatus via the entry opening 14, for instance by way of a conveyor belts, by a truck or container unloading over the opening. The containers drop onto the screen of rotating rotors 3 that define the transport path 4. The rotors 3 are composed of shafts and star shaped impellers that intermittently throw up the containers with a directional component in the transport direction 5 and thereby urge the containers in the transport direction towards the pressing rotor 7 and the perforating rotor 6, where the containers are deformed and perforated.

Between surfaces of the fingers 8 that are leading in rotational sense and the perforating rotors 8, intermittently a gap 19 occurs between a leading surface of a finger 8 approaching the perforating rotor 6 and the circumference of the perforating rotor 6. The width of the gap 19 decreases as the rotors 6, 7 continue to rotate, thereby causing containers that have been received in the gap 19 to remain caught (without escaping in a direction opposite the transport direction) and deformed reliably, in spite of the absence of container gripping perforating elements on the circumference of the pressing rotor 7.

The containers are generally to some extent unevenly distributed in transport direction 5 and across the width of the transport path 4. The gaps do to some extent regulate the amount of containers that are deformed and perforated simultaneously. If occasionally, the supply of containers exceeds the capacity of the gaps, containers that are fed from the most downstream one of the rotors 3 tend to drop back and be processed in a next gap that occurs. Thus, the amounts of containers that is deformed simultaneously is, at least to some extent evened out in transport direction 5.

Moreover, not all the containers will deform at the same pressure and at the same speed. In operation, the fingers 8 can preferably bend when encountering a large resistance from one or more containers. Preferably, flexibility of the fingers 8 allows the pressing rotor 7 to accommodate quickly to variations in compressibility of the containers passing between the pressing rotor and the perforating rotor. In particular, the fingers 8 contacting the containers may bend slightly if a container is initially difficult to compress because it is not yet perforated and then flex back quickly, thereby compressing the container, in response the a reduction of the encountered compression resistance once the container is perforated. The accommodation of the fingers 8 to differences in compressibility moreover causes the overall pressure of the pressing rotor 7 to be distributed relatively evenly over the width of the transport path 4.

After a container has been deformed, it is transported further along the transport path 4. In the embodiment shown, the deformed containers fall down towards an output opening 15. Below this opening 15 for example a conveyor belt may transport the deformed containers away.

In the embodiment shown, only a single pressing rotor 7 is arranged opposite the perforating rotor 6. Thus a simple and low cost construction is obtained. Because the flexible fingers 8 can accommodate to the compression of passing containers, a transport path section of substantial length in which the distance between perforating rotors reduces gradually in transport direction is not necessary for compressing the containers as perforation allows the containers to be compressed.

However, as in the present example, it is preferred that the diameter of the rotary contour of the pressing rotor 7 is large, preferably at least two times the diameter of the rotary contour of the perforating rotor 6, so that the containers are engaged by a finger over a relatively long trajectory and more time is available for perforating and deforming the containers as the perforations made allow air to escape from the containers. It is observed that a large diameter rotary trajectory is also advantageous if more than one pressing rotor is provided, for instance two or more pressing rotors arranged in succession along the transport path. The rotary contour of a rotor is understood to be the contour of the rotational trajectory through which the rotor passes as the rotor rotates about is axis of rotation.

Preferably, at least the leading surface portions of the fingers 8 are made of an elastomeric material such as rubber, and more preferably, at least the entire fingers 8 are made of such material, but the fingers may also include spring elements, for instance made of spring steel. The elastomeric material allows containers to be pressed against the perforating elements of the perforating rotor 6 without slipping away easily, yet can accommodate to variations in deformability of the containers.

According to the present example, the pressing rotor 7 shown is composed of a shaft concentric with the axis of rotation of the pressing rotor 7 and a plurality of star bodies 9 each having a plurality of resilient fingers 8 (only a few of the star bodies and fingers are designated by reference numerals). The fingers 8 each have a width in a direction parallel to the rotational axis of the pressing rotor 7 smaller than 10 cm and more preferably smaller than 6 cm. By providing an array in axial direction of relatively slender fingers, the pressing rotors can accommodate finely to variations over the width of the transport path 4 in the compressibility and thickness of containers being perforated and deformed. However, within the framework of the present invention, it is also conceivable to provide that the resilient fingers each extend over a substantial portion or even the entire width of the transport path 4. In such an apparatus, the fingers are preferably flexible enough to bend to allow adjacent portions of the finger to bend to different extents in accordance with differences in resistance encountered from containers that are being deformed simultaneously.

The pressing rotor 7 is supported in a deforming position, in this position the distance between its axis of rotation and the transport path 4 is preferably adjustable for exerting an optimal force upon containers transported along the transport path 4 beneath the pressing rotor 7. This distance, and thus the deforming position, is preferably adjustable by the machine operator, for instance to accommodate to the properties of containers material to be processed.

The pressing rotor 7 is suspended to the frame 2 via support arms 11a, 11b that are pivotably mounted to the frame 2. This allows the pressing rotor 7 to move away from the perforating rotor, for example when a non compressible object, or an object with a high resistance against deformation, passes between the pressing rotor 7 and the perforating rotor 6 to prevent damage to the resilient fingers 8 and/or blocking of the apparatus 1.

For controlling the pressure of the pressing rotor 7 towards the perforating rotor 6, resilient elements 12 are provided for exerting a force urging the pressing rotor 7 away from the transport path 4. The closest distance between the pressing rotor 7 and the perforating rotor 6 is also adjustable and movement of the pressing rotor 7 towards the perforating rotor is damped by another resilient element 21 to prevent a too strong impact when the closest distance between the pressing rotor 7 and the perforating rotor 6 is reached.

Furthermore, the fingers 8 will absorb part of the impact before the pressing rotor 7 as a whole is caused to move away from the transport path 4 in response to the encountered increase in the overall resistance of the container material being deformed.

In the present embodiment, the perforating elements are formed by sharp teeth formed in the circumference of disc bodies 17, 18. Such disc bodies 17, 18 can be manufactured efficiently and can be replaced easily if worn. The disc bodies may for instance be made of steel, for example steel plate having a hardness of at least 400 HBW and have a rotary contour with a diameter of 330 mm.

According to the present example, portions 10 of the perforating rotor 6 between the disc bodies 17, 18 and rotary contours of the disc bodies 17, 18 have different diameters (only a few of the portions 10 and the disc bodies 17, 18 are designated by reference numerals). The diameter of the sections 10 of the perforating rotor 6 between the disc bodies 17, 18 is smaller than the diameter of the rotary contours of the disc bodies 17, 18. This allows pressure exerted onto the containers from the perforating rotors 6 to be transferred mainly via the perforating elements, which is advantageous for effective perforation of the containers.

The portions 10 of the perforating rotor 6 and the smaller ones 18 of the discs 17, 18 between the larger ones 17 of the discs 17, 18 are positioned diametrically opposite the resilient fingers 8 of the star body 9. Thus, the resilient fingers 8 press a container in-between two disc bodies 17 of the larger diameter. The container is thus subjected to extensive stress, reliably causing perforation of the container and if no container is present between the fingers 8 and the perforating rotor 6, the fingers 8 nevertheless do not contact the large discs 17 but pass in-between adjacent ones of the larger discs 17 so that damage to the fingers 8 is avoided.

Since the rotary contours of the larger ones 17 of disc bodies 17, 18 are interleaved with the rotary contours of the resilient fingers 8 of the pressing rotor 7, the fingers 8 and disc bodies 17 are evenly distributed over the width of the transport path 4.

Since discs 18 of smaller diameter with perforating elements on the circumferences thereof are arranged between the larger discs 17, containers are also pressed directly between fingers 8 and perforating elements of the perforating rotor 6, which is also advantageous for reliable perforation, in particular of smaller containers that pass between the pressing rotor 7 and the perforating rotor oriented in the transport direction 5.

Downstream of the perforating rotor and the pressing rotor crushing rotors with or without resilient fingers may be provided so that the containers can be compressed further.

From the foregoing, it will be clear to the skilled person, that within the framework of invention as set forth in the claims also many variations other than the example described above are conceivable. For instance, the star bodies for pressing containers against the perforating rotor may each be separately supported, instead of all on a common shaft. Also, the pressing rotor may be disposed generally under the transport path, and the perforating rotor may be arranged generally above the transport path. Furthermore, instead of, or in addition to the pressing rotor being suspended from the frame via hinged support arms, the perforating shaft may suspended from the frame via hinged support arms. Also, two or more pressing rotors can form a screen extending along, and at an angle to the transport path for stepwise compression of the containers transported in the transport direction. However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the words ‘a’ and ‘an’ shall not be construed as limited to ‘only one’, but instead are used to mean ‘at least one’, and do not exclude a plurality. The mere fact that certain measures are recited in mutually different claims does not indicate that a combination of these measures cannot be used to advantage.

1. An apparatus for perforating and deforming containers, comprising:
a transport path for transporting the containers in a transport direction;
at least one perforating rotor comprising sharp perforating elements on an outer circumference for perforating the containers, the at least one perforating rotor being rotatable about an axis of rotation on a first side of the transport path and oriented transverse to the transport direction;
at least one pressing rotor for pressing the containers against the perforating rotor such that the containers are perforated and compacted between the pressing rotor and the perforating rotor, the at least one pressing rotor being rotatable about an axis of rotation on a second side of the transport path, opposite the at least one perforating rotor and oriented transverse to the transport direction and comprising a plurality of circumferentially distributed fingers each projecting in a direction radial and circumferential with distal ends trailing relative to the axis of rotation of the at least one pressing rotor; and
a drive for driving rotation of the at least one perforating rotor and the at least one pressing rotor in a sense of rotation such that sections of the rotors facing the transport path move in directions having a component in the transport direction.

2. An apparatus according to claim 1, wherein only a single pressing rotor is arranged opposite the at least one perforating rotor.

3. An apparatus according to claim 2, wherein rotary contours of the at least one pressing rotor and of the at least one perforating rotor have different diameters, the diameters of the rotary contour of the pressing rotor being at least twice as large as the diameter of the rotary contour of the at least one perforating rotor.

4. An apparatus according to claim 1, wherein the at least one pressing rotor comprises a shaft and a plurality of star bodies each comprising a plurality of said resilient fingers.

5. An apparatus according to claim 1, wherein the at least one perforating rotor comprises a shaft and a plurality of disc bodies each comprising a plurality of the perforating elements.

6. An apparatus according to claim 5, wherein sections of the perforating rotor between the disc bodies and rotary contours of the disc bodies have different diameters, the diameter of the sections of the perforating rotor between the disc bodies being smaller than the diameter of the rotary contours of the disc bodies.

7. An apparatus according to claim 7, wherein rotary contours of at least largest ones of the disc bodies are interleaved with rotary contours of the resilient fingers of the at least one pressing rotor.

8. An apparatus according to claim 1, wherein the axis of rotation of the pressing rotor is located above the transport path.

9. An apparatus according to claim 1, wherein the fingers have a flexibility for causing the fingers to yield in response to resistance encountered during compacting the containers.

10. An apparatus according to claim 1, wherein at least surface portions of the fingers that are leading when rotating, are of elastomeric material, such as rubber.
